(19) United States
(12) Patent Application Publication
(10) Pub. No.: US 2004/0094862 A1
(43) Pub. Date: May 20, 2004

(54) Multi-screw extruder and method for treating and/or processing elastomers with added filler

(76) Inventors: Achim-Philipp Sturm, Niederuzwil (CH); Federico Innerebner, Zurich (CH)

Correspondence Address: Gerald H Kiel, Reed Smith, 599 Lexington Avenue, New York, NY, 10022-7650, US

(21) Appl. No.: 10/399,137

(22) PCT Filed: May 30, 2001
(86) PCT No.: PCT/CH01/00336

(30) Foreign Application Priority Data
Oct. 10, 2000 (DE) 100 50 295.4

(51) Int. Cl. B29C 47/60; B29B 7/48

(52) U.S. Cl. 264/211; 264/211.23; 425/204; 425/209; 366/85

(57) ABSTRACT

A multi-shaft extruder is disclosed with at least two shafts for compounding and/or molding an elastomer staggered with filler, in particular rubber, with at least one softener and/or additives. The extruder comprises the following in succession in the direction of product transport: a feed zone, into which the elastomer and softener and/or additives are metered; a mastication/plasticization zone with at least one kneading element, into which the elastomer with the softener and/or additives is transferred to a flowable, cohesive mixture; a dispersing zone with at least one additional kneading element, in which the filler in the elastomer is comminuted and distributed; and the kneading elements having a comb and the extruder having a casing inner wall and wherein a gap with a gap width Z of about 1/100 to about 1/10 of the kneading element diameter D is present between the comb of the kneading elements and the casing inner wall of the extruder, wherein the diameter is defined as the maximal diameter of a kneading element from comb to comb.

### CROSS-REFERENCE TO RELATED APPLICATION

This application claims priority of International Application No. PCT/CH01/00336, filed May 30, 2001 and German Application 100 50 295.4, filed Oct. 10, 2000, the complete disclosures of which are hereby incorporated by reference.

### BACKGROUND OF THE INVENTION

a) Field of the Invention

The invention relates to a multiple-shaft extruder and a procedure for compounding and/or molding an elastomer laced with filler, e.g., rubber with carbon black.

b) Description of the Relevant Art

Multistage and discontinuous procedural steps are known for compounding rubber mixtures. The rubber is prepared in batch mixers with a content of 250-500 1 in approx. 2-3 minute mixing cycles, mostly in 2 passes. Subsequent molding takes place either by open roll mills (for tires) or extruders (for profiles, etc.). The high costs associated with building and equipping the mixing hall coupled with the high operating outlays make it difficult to lower production costs.

The rubber industry has been trying for years to simplify the molding process. The continuous compounding of rubber, e.g., in a manner known in the thermoplastics industry, has been regarded as a potential solution for years. It is hoped that a continuous process will yield the following main advantages:

Lower fluctuations (in particular in quality) and product losses

Largely automated procedure

Low energy consumption

Low emissions

The Continuous compounding of rubber has been sought by the rubber industry for years. A continuous mixing process adapted for rubber compounding presupposes an ability to continuously meter all mixing components, and an exact metering of these constituents. The usual form of delivery of rubber, in which the rubber (natural and synthetic) was as a rule delivered in balls, has previously hampered efficient continuous compounding. Powdered rubber has long been known, but has been too expensive so far. More recent developments that permit a cost-effective production of powdered rubber are opening up new possibilities for continuous rubber compounding.

For example, powdered rubber laced with filler has most recently been obtained via co-precipitation between a rubber emulsion and a filler suspension by means of subsequent drying and filtration. The powdered rubber obtained in this way is free-flowing and pourable.

Currently known procedures for mixing rubber generally employ a closed mixer with tangential or intermeshing kneading shafts, a blanking roll mill with stock blender and/or a batch-off roll mill for homogenizing the mixed charges and cutting the obtained mixtures into rolled sheets or feed strips before cooling takes place in the batch-off system.

As an alternative, a melt extruder and a roller-die arrangement is used.

To ensure a good dispersion of the mixture without running the risk of too intensive a heating or a kickoff of the mixture, a two-stage mixing process is often required when mixing in individual charges, in particular in mixtures with a greater hardness or high Mooney viscosity values. To ensure good polymer dispersion, mixtures for articles with low a low hardness require longer mixing times, and mixing in several passes.

The current mixing process is capital-intensive, and generates high energy and operating costs. In addition, there is always the risk of fluctuating product quality, not only because large rubber balls with varying ball density are used, but very simply because this mode of production by mixing in single charges is by its nature variable, and also involves numerous procedural steps.

The closed mixer (or kneader) remains the central aggregate during the manufacture of rubber mixtures. Two massive mixing blades whose geometry is such that a simultaneous axial and radial shifting or mixing of the material being blended takes place rotate inside the closed mixer.

The kneading blades conventionally run at varying speeds, in opposite directions, and, in modern closed mixers, are intermeshing.

Closed mixers are available in capacities of 1 liter (laboratory machines) Up to 450 liters (tire kneaders). The latter take up several floors, and require investments of several million francs.

The filling hole lies over the blade gap. It is sealed with a hydraulically activated stamp while mixing. The material to be blended is pressed into the actual mixing chamber with a stamping pressure of 2 to 10 bar, and prevented from escaping. The mixing times typically lie at 2 minutes.

The walls of the mixing chamber have cooling holes. The kneading blades also have holes in them for cooling purposes.

The evacuation hole on the floor of the mixing chamber is sealed by so-called sliding or hinged saddles. The hole is quickly opened to full size with the hinged saddle, thus enabling a rapid evacuation.

Closed mixers are powered by high-performance electric motors of up to 10 kW per kg effective capacity. Modern closed mixers are infinitely variable in terms of blade speed.

The closed mixer is loaded semi-automatically by so-called primary switchgear. Pourable fillers, e.g., carbon black, are automatically discharged from filler devices (containers, silos or flexible big-bags), weighed and fed to the closed mixer. Oft-changing small quantities and ball-shaped rubbers are weighed in by hand after comminuted in the ball cutter. The constituents weighed in advance during manual weighing are placed in the kneader shaft.

After the rubber, the fillers and additives are added together, and the liquid components (softeners) are sprayed in at the end.

The rubber is warmed and plasticized in a first phase at low mixing process speeds. Mixing operations (distributive and dispersive) are then introduced at higher speeds. Temperature is the limiting factor during mixing operations. The mass temperature and power consumption of the kneader drive are measured in order to monitor and control the mixing process. Both taken together yield a characteristic picture that must be reproduced from cycle to cycle to obtain uniform mixing properties. The finished mixture falls out of the closed mixer onto a mixing or cooling roll mill with stock blender, is there drawn off as a continuous sheet, and cooled in the batch-off system, provided with release agents, dried and subsequently cut into strips and place don pallets.

One important step during the molding of elastomers such as rubber is to lace them with filler, e.g., carbon black or silicate. The physical properties can be changed in a targeted fashion with this filler. For example, adding 50-60% by weight of carbon black to styrene-butadiene rubber or isoprene rubber (natural rubber) enables a significant increase in tear strength.

In this first step, certain molding aids are commonly used. For example, plasticizer oil is added while molding rubber in order to reduce the mixture viscosity and mixture elasticity. This makes it easier to masticate the powdered rubber, and the carbon black can be better dispersed, i.e., comminuted and distributed, in the rubber.

For rubber production, it is necessary to cross-link the chain molecules of the rubber with each other in another step. Primarily sulfur is used for this purpose. Silica, metal oxides or peroxides are used as an alternative. In certain elastomers, cross-linking can also be initiated via UV irradiation. The chain molecules of the rubber are then interconnected by sulfur bridges, giving rise to highly elastic rubber.

Other additives improve the required product properties or serve as molding aids, stabilizers, etc.

Previous extrusion processes have always required a high energy outlay, which occasionally also led to thermal damage to the materials being molded.

### OBJECT AND SUMMARY OF THE INVENTION

Therefore, the primary object of the invention is to achieve a reduction in energy outlay during the compounding and/or molding of the elastomer laced with filler, without appreciably impairing the quality of the end product.

In accordance with the invention, a multi-shaft extruder with at least two shafts for compounding and/or molding an elastomer staggered with filler, in particular rubber, with at least one softener and/or additives, comprising the following in succession in the direction of product transport: a feed zone into which the elastomer and softener and/or additives are metered; a mastication/plasticization zone with at least one kneading element, into which the elastomer with the softener and/or additives is transferred to a flowable cohesive mixture (compound); a dispersing zone with at least one additional kneading element, in which the filler in the elastomer is comminuted and distributed; and the kneading elements have a comb therebetween and the extruder has a casing inner wall and wherein a gap with a gap width of Z of about 1/100 to about 1/10 of the kneading element diameter D is present between the comb of the kneading elements and the interior casing inner wall of the extruder. The diameter is defined as the maximal diameter of a kneading element from comb to comb.

Also in accordance with the invention, a procedure for compounding an elastomer staggered with filler, in particular rubber, with a softener and/or additives, by an extruder as described above, wherein the procedure comprises the following steps: metering in the elastomer and softener and/or additives, masticating/plasticizing the product with at least one kneading element, wherein the elastomer with the softener and/or additives is brought to the state of a flowable, cohesive mixture, dispersing the product with at least one additional kneading element, wherein the filler in the elastomer is comminuted and distributed and operating the shafts carrying the kneading elements at speeds ranging from about 100 rpm to about 300 rpm.

The gap according to the invention between the comb of the kneading elements (kneading disks) and interior casing wall of the extruder according to the invention makes it possible to achieve a reduction of the screw torque, and hence the energy outlay, by up to half at a practically constant dispersion (i.e., level of distribution and commination) of the end product at the extruder output, depending on the screw speed and selected gap width. Depending on requirements, it can be ensured that the gap width measured in a radial direction of the gap extending in an axial direction between the kneading element combs and interior casing wall of the extruder is variable over the width of a kneading element or kneading disk as a function of the axial position, or that this gap width is constant along the axial direction over the entire width of a kneading element.

The gap width and speed range of the shafts bearing the kneading elements is preferably designed in such a way as to achieve shearing rates of roughly 10/s to about 3000/s, in particular between 30/s and 1000/s.

In addition, a gap extending perpendicular to the axial product conveyor between consecutive kneading disks can further help shear the product.

A metering device for metering in softener and/or additives in the conveyor-upstream end region of the feed zone is best provided, wherein in particular a metering device can be provided for metering in softener and/or additives along the product conveying direction over at least a partial area of the feed zone. The mastication/plasticization zone and/or the dispersing zone then preferably has a vent in its conveyor-downstream area.

In another advantageous form of execution, the feed zone or conveyor area of the extruder has a device for the metered supply of water. This makes it possible to incorporate water into the product, and cool not just its surface, but inside the product volume, so that thermal product damage can be effectively prevented. The essential cooling effect here stems primarily from the evaporation heat of the water vapor escaping through the vents.

The mastication/plasticization zone and dispersing zone each best have numerous (kneading block) adjacent kneading disks, whose width preferably ranges between about ⅙ the diameter and about 1 diameter of the kneading disks. This stacked arrangement is particularly well suited for screws, which must often be adapted to different operating conditions. The kneading disk stack can also be fabricated as a single piece, e.g., by casting or machining.

The adjacent kneading disks can here be offset by 90° relative to each other, or offset by less than 90° in or opposite the direction of rotation. This results in a neutral kneading effect without conveyor component, or a kneading effect with superposed returning or conveying component. The suitable selection of these configurations makes it possible to achieve more or less intensive mastications and dispersions, but in particular a targeted banking and pressure buildup in front of vents.

Kneading disks whose comb-to-comb diameter decreases (increasing gap width) or increases (decreasing gap width) along the conveying direction are preferably used inside a kneading block of the masticating section and/or dispersing section of a screw. In this way, a conveying or returning, i.e., banking, effect can also be exerted on the product in the respective zone.

The feed zone is best as long as the sum of lengths of the mastication/plasticizion zone and the dispersing zone, and advantageously has distributive or non-tightly combing elements. This makes it possible to initially distribute the product components well, without having to initiate major dispersive operations (commination). Above all, the distributive mixing, long feed zone also gives the softener enough time to be initially well distributed, and diffuse into the elastomer.

Possible multiple-shaft extruders include a ring extruder, which has both a casing and core cooling. This enables a particularly effective cooling of the product, since heat is removed both inside the annular processing zone of the extruder and outside of it. The ring extruder, in particular as tightly combing multiple-shaft extruder rotating in the same direction, offers clear advantages relative to the dual-shaft extruder. The inventors of this application for continuous rubber compounding can use the ring extruder to offer a unique, particularly advantageous solution for the compounding of rubber, wherein the following five main criteria must be met:

Optimal mixing distribution (distributive mixing)

Small particles and narrow particle size distribution (dispersive mixing)

No thermal damage owing to time-temperature history

Low energy consumption

No gas

The higher specific variables, such as cylinder surface and intermeshing zone area, make it possible to reach these criteria more efficiently with the ring extruder than with a conventional dual-shaft extruder.

In particular dispersive mixing can be achieved many times as fast and gently with the ring extruder. The reasons have to do with its smaller passive volume, its narrower target variable distribution, and its larger specific heat transfer surface.

Therefore, especially the ring extruder is suitable as a continuously operating machine for rubber compounding.

The conveyor-downstream end of the extruder best contains yet another molding device, in particular with an upstream discharge apparatus. In this way, for example, powdered rubber can be molded into a shaped end product on one line.

Operating the shafts bearing the kneading elements in such a way as to achieve shear rates of about 10/s to about 3000/s, in particular between 30/s and 1000/s, between the combs of the kneading elements and the interior casing wall ensures that there is enough of a shearing effect to achieve a sufficient mastication and dispersion in the corresponding zones.

The product obtained at the output of the extruder is a pourable, coherent mixture containing primarily elastomer (e.g., rubber) and filler (e.g., carbon black or silicate) and softener (oil). In this case, the elastonier represents the continuous (coherent) phase, and the distributed and comminuted filler represents the discontinuous phase of the mixture.

The softeners and/or the additives are best metered in on the conveyor-upstream end area of the feed zone, but can also be metered in along the product conveying direction distributed over at least a partial area of the feed zone, if necessary.

As an alternative, the softener and/or additives can be metered into a conveyor-downstream partial area of the feed zone.

Preferably, degasification takes place in the area of the mastication/plasticization zone and/or dispersing zone, in particular for cases where water is metered into the area of the feed zone.

If a ring extruder is specially used, both the casing and core of the multiple-shaft extruder are advantageously cooled.

The product is bet discharged at the conveyor-downstream end of the extruder, and then shaped.

An elastomer parent material (powdered rubber) is preferably used, which already contains parts of the additives and/or softeners (carbon black), and whose dispersion in the elastomer is then increased by the procedure according to the invention.

Further advantages, features and possible applications of the invention are specified in the following description of an embodiment according to the invention based on the drawings.

### BRIEF DESCRIPTION OF THE DRAWINGS

In the drawings:

FIG. 1 is a diagrammatic side view of the extruder according to the Invention;

FIGS. 2a and 2b are each a diagrammatic view of the various zones of the extruder screws for two different variants;

FIGS. 3a and 3b are a side view or axial view of a kneading block according to the invention comprised of two kneading elements;

FIG. 4 is a diagram that shows the correlation between the gap width or kneading disk diameter and required screw torque; and

FIG. 5 is a section through an extruder having the kneading disks according to the invention, perpendicular to its longitudinal axis.

### DESCRIPTION OF THE PREFERRED EMBODIMENTS

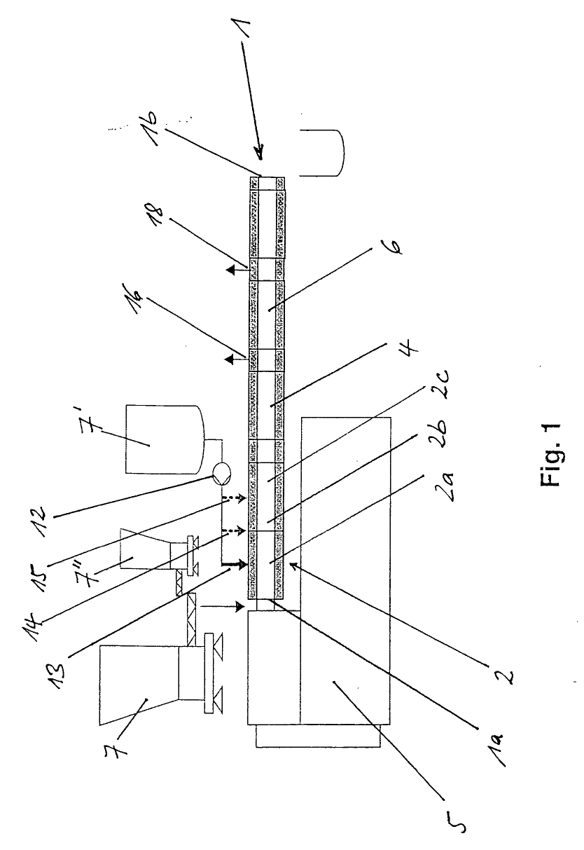

FIG. 1 shows an extruder according to the invention in a diagrammatic side view. In the extruder, an elastomer laced with a filler like carbon black or silicate, e.g., powdered rubber, is compounded or molded, with the objective of comminuting and uniformly distributing the carbon black particles in the powdered rubber. The dispersion (level of comminution and distribution of carbon black particles) is a quality feature of the end product.

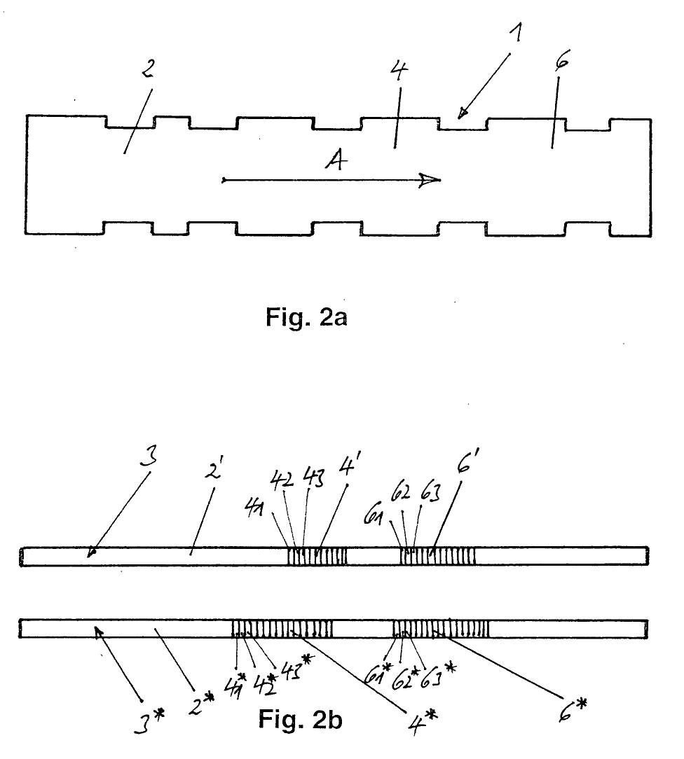

The extruder has a casing 1, which contains a pair of screws 3 or a pair of screws 3* (see FIG. 2). The screws 3 or 3* are powered by a motor/drive unit 5 of the extruder. In the conveying direction (from left to right), the extruder casing 1 has a feed zone 2, a masticating zone 4 and a dispersing zone 6, in that order. The powdered rubber is supplied to the extruder casing 1 at its conveyor-upstream end 1 a from a storage vessel 7.

The softener, e.g., oil, is supplied from the storage vessel 7′ via a metering unit 12 and a metering line 13 to the conveyor-upstream partial area 2a of the feed zone 2. As an alternative, the softener can also be supplied distributed over the feed zone 2, namely by means of the metering lines 13, 14 and 15 in the conveyor-upstream, central and conveyor-downstream partial areas 2a, 2b, 2c of the feed zone 2.

In the masticating zone 4 and dispersing zone 6, the product is subjected to shear and thorough mixing in the extruder casing 1 in order to comminute and distribute the carbon black or silicate particles, wherein distribution takes place predominately in the masticating zone 4, and comminution predominately in the dispersing zone 6. Additives or even water can be metered in from an additional storage vessel 7″. In the area of the masticating zone 4 and dispersing zone 6, the extruder casing 1 has a vent 16 or 18, through which the metered water and possibly the softener are removed from the product before it leaves the extruder casing 1 at its conveyor-downstream end 1b.

FIG. 2a is a diagrammatic view of the extruder casing 1 with its feed zone 2, its masticating zone 4 and its dispersing zone 6. The product conveying direction is denoted by the arrow A.

FIG. 2b shows a diagrammatic view of two variants of screws 3 and 3*, of which at least two are situated parallel to each other and partially intermesh in the extruder casing 1.

In the conveying direction, the screw 3 (first variant) consists of a feed section 2′, a masticating section 4′ and a dispersing section 6′, in that order. The feed section or conveying section 2′ of the screw 3 has non-combing distributive elements. The product is here conveyed and simultaneously exposed to an initial mixing. The ensuing masticating section 4′ incorporates conveying screw elements that build up pressure in the product and have a tapering lead (not shown), as well as kneading blocks that consist of rowed kneading disks 41, 42, 43, etc., and have primarily a shearing effect on the product. The ensuing dispersing section 6′ also incorporates conveying screw elements with tapering lead (not shown), as well as kneading blocks, which consist of rowed kneading disks 61, 62, 63, etc. (shown diagrammatically). The effect of these screw elements and kneading blocks is here similar to the preceding section 4′.

The screw 3* (second variant) has a layout similar to screw 3, but has a short feed section 2*, a longer masticating section 4* and a longer dispersing section 6*. In particular, the kneading blocks of sections 4* and 6* have a larger number of kneading disks 41*, 42*, 43*, etc. or 61*, 62*, 63*, etc.

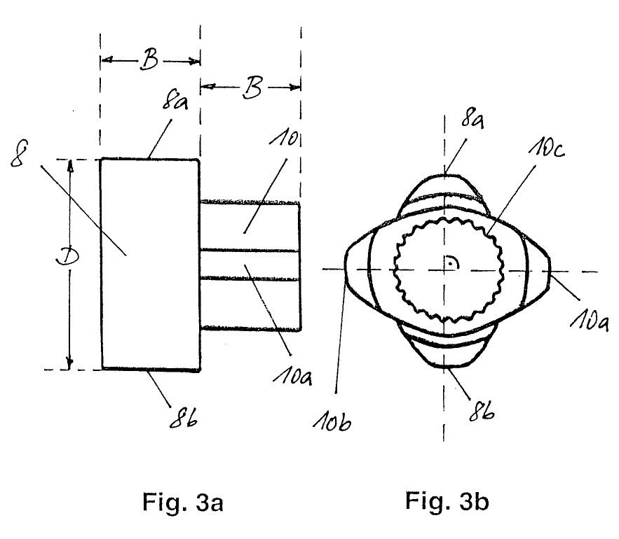

In both the screw 3 and screw 3*, a gap whose gap width Z can range from about 1/100 to 1/10 of the kneading disk diameter D is present between the combs 8a, 8b, 10a, 10b of the kneading disks (8, 10 (see FIGS. 3a, 3b) and the interior casing wall 9 of the extruder casing 1.

In the screw 3, the masticating section 4′ has a kneading block, which has (neutral) kneading disks offset by 90° in its conveyor-upstream area, and (returning) kneading disks offset by less than 90° in the rotational direction in its conveyor-downstream area, while the kneading block of the dispersing section 6′ only has neutral kneading disks.

In the screw 3*, the masticating section 4* has a kneading block, which has (conveying) kneading disks offset by less than 90° opposite the rotational direction in its conveyor-upstream area, and (returning) kneading disks offset by less than 90° in the rotational direction in its conveyor-downstream area, while the kneading block of the dispersing section 6* only had neutral kneading disks. As opposed to screw 3, however, the kneading blocks of the masticating section 4* and the dispersing section 6* each have kneading disks in their conveyor-upstream area with a larger diameter than in the conveyor-downstream area, i.e., the gap width between the combs of the kneading disks and the interior casing wall increases along the product conveying direction. This configuration also has a conveying effect.

FIG. 3a shows a kneading block viewed in a radial direction, which consists of two kneading disks 8, 10, which are twisted by 90° around the screw axis. The width B of the kneading disks 8, 10 is roughly half the diameter D of the kneading disks, wherein the diameter is to be interpreted as the “maximal diameter” of a kneading disk 8, 10 from comb 8a to comb 8b, or from comb 10a to comb 10b.

FIG. 3b shows the kneading block on FIG. 3a viewed in an axial direction. Evident here is the interior gearing 10c with which the kneading disks 8, 10 can be positively mounted shifted by a specific number of teeth in the circumferential direction on complementary exterior gearings of the screw shafts (not shown).

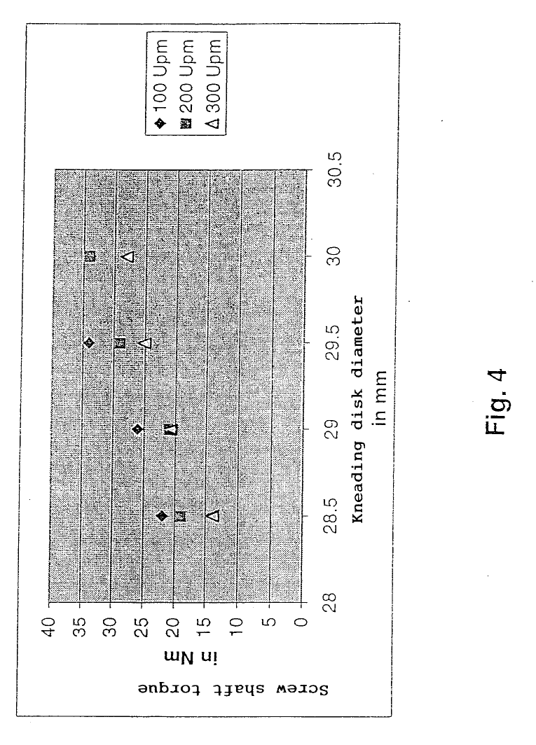

FIG. 4 shows the correlation between gap width or kneading disk diameter and the required screw torque. As evident, the necessary screw shaft torque, and hence the energy to be applied, decreases as the gap width Z between the kneading disk combs and interior casing wall increases. Surprisingly, the dispersion of the end product remained virtually unchanged.

A slight dependence of the screw shaft torque on speed is also evident. In the 100 RPM to 300 RPM range, the required torque decreases with increasing speed. For example, at a speed of 300 RPM, a decrease in screw shaft torque from 28 Nm to 1 5 Nm could be measured by decreasing the kneading disk diameter D by 1.5 mm., i.e., by increasing the gap width Z by 0.75 mm over each comb in the kneading disk.

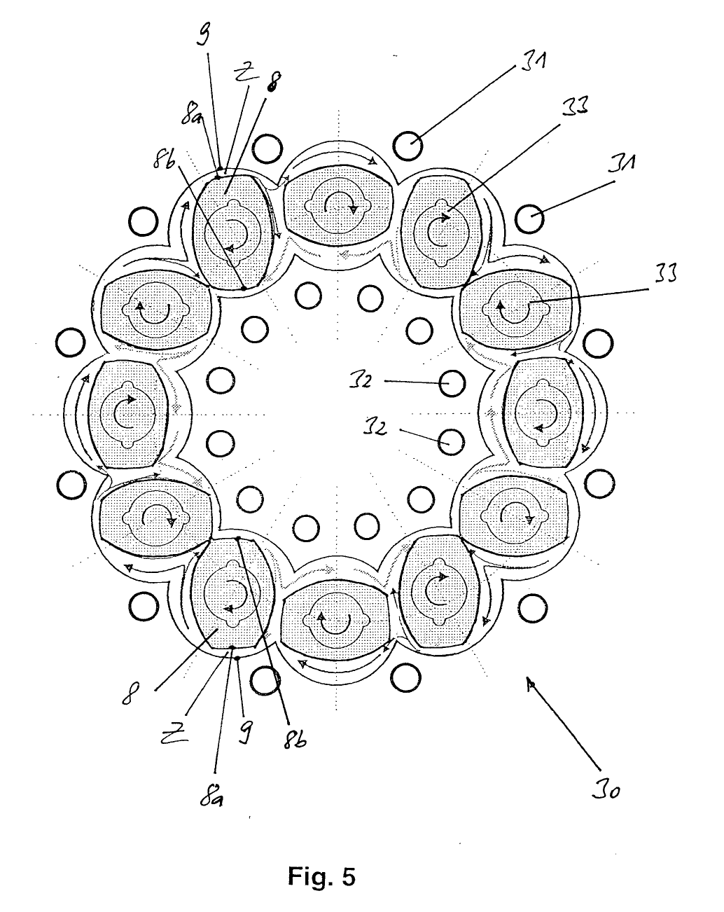

FIG. 5 shows a section through a ring extruder 30 having the kneading disks 8 according to the invention perpendicular to its longitudinal axis. It contains twelve screw shafts 33 that rotate in the same direction. The cutting plane accommodates a kneading disk 8 mounted on the respective screw shaft 33, whose combs 8a, 8b form a gap with the interior casing wall 9 of the extruder 30 measuring roughly 1/10 of the kneading disk diameter D. The extruder 30 has both an interior core cooling system 32 and exterior casing cooling system 31.

While the foregoing description and drawings represent the present invention, it will be obvious to those skilled in the art that various changes may be made therein without departing front the true spirit and scope of the present invention.

Reference List

1 Extruder casing

1a, 1b Conveyor-upstream, conveyor-downstream end

2 Feed zone/conveying zone (relative to casing 1)

2a, 2b, 2c Conveyor-upstream, central, conveyor-downstream partial area

3, 3* Screw shaft

4 Masticating zone (relative to casing 1)

5 Motor/gearing block

6 Dispersing zone (relative to casing 1)

2′, 2* Feed section (relative to screw 3, 3*)

4′, 4* Masticating section (relative to screw 3, 3*)

6′, 6* Dispersing section (relative to screw 3, 3*)

7, 7′, 7* Storage vessel

8, 10 Kneading element/kneading disk

8a, 8b, 10a, 10b Comb

9 Interior casing wall

8c, 10c Interior gearing

12 Metering unit

13, 14, 15 Metering line

12, 13, 14, 15 Metering arrangement

16, 18 Vent

41, 42, 43, . . . Masticating kneading disk (=kneading block) on screw shaft 3

61, 62, 63, . . . Dispersing kneading disk (=kneading block) on screw shaft 3

41*, 42*, 43*, . . . Masticating kneading disk (=kneading block) on screw shaft 3*

61 *, 62*, 63*, . . . Dispersing kneading disk (=kneading block) on screw shaft 3*

30 Ring extruder

31 Casing cooling system

32 Core cooling system

1. A multiple-shaft extruder with at least two shafts for compounding and/or molding an elastomer laced with filler, in particular rubber, with at least one softener and/or additives, wherein the extruder has the following one after the other in the direction of product transport:
a feed zone (2), in which the elastomer along with the softener and/or the additives are metered;
a masticating/plasticizing zone (4) with at least one kneading element (8, 10), in which the elastomer along with the softener and/or the additives is transferred to a pourable, coherent mixture (compound); and
a dispersing zone (6) with at least one additional kneading element (8, 10), in which the filler is comminuted and distributed in the elastomer,
characterized in that
a gap with a gap width Z of about 1/100 to about 1/10 of the kneading element diameter D is present between the comb (8a, 8b, 10a, 10b) of the kneading elements (8, 10) and the interior casing wall (9) of the extruder.

2. The extruder according to claim 1, characterized in that the width of the gap and speed range of the shafts carrying the kneading elements are designed in such a way as to achieve shearing rates of about 10/s to about 3000/s, in particular between 30/s and 1000/s.

3. The extruder according to claim 1 or 2, characterized in that a metering device (12, 13) is provided for metering in softener and/or additives in the conveyor-upstream end area (2a) of the feed zone (2).

4. The extruder according to one of claims 1 to 3, characterized in that a metering device (12, 13, 14, 15) is provided for metering in softener and/or additives along the product conveying direction distributed over at least a partial area (2a, 2b, 2c) of the feed zone (2).

5. The extruder according to one of the preceding claims, characterized in that the masticating/plasticizing zone (4) and/or the dispersing zone (6) each have a vent (16, 18).

6. The extruder according to claim 5, characterized in that the feed zone (2) or the conveying area has a device for the metered supply of water.

7. The extruder according to one of the preceding claims, characterized in that the masticating/plasticizing zone (4) as well as the dispersing zone (6) each have a kneading block consisting of numerous kneading disks (41, 42, 43, . . . or 61, 62, 63, . . . ) adjacent in an axial direction.

8. The extruder according to claim 7, characterized in that the width B of the kneading disks ranges from between 1/6 of the diameter D and about 1 diameter D of the kneading disks (41, 42, 43, . . . , 61, 62, 63, . . . ).

9. The extruder according to claim 7 or 8, characterized in that the adjacent kneading disks (41, 42, 43, . . . or 61, 62, 63, . . . ) are each offset by 90° relative to each other.

10. The extruder according to claim 7 or 8, characterized in that the adjacent kneading disks are offset by less than 90° in the rotational direction (returning), or by less than 90° opposite the rotational direction (conveying).

11. The extruder according to one of claims 7 to 10, characterized in that the maximum diameter D of the kneading disks (41, 42, 43, . . . ; 41*, 42*, 43*, . . . ) of the masticating section (4′; 4*) decreases along the product conveying direction.

12. The extruder according to one of claims 7 to 11, characterized in that the maximum diameter D of the kneading disks (61, 62, 63, . . . ; 61*, 62*, 63*, . . . ) of the dispersing section (6′; 6*) decreases along the product conveying direction.

13. The extruder according to one of claims 7 to 10 or according to claim 12, characterized in that the maximum diameter D of the kneading disks (41, 42, 43, . . . ; 41*, 42*, 43*, . . . ) of the masticating section (4′; 4*) increases along the product conveying direction.

14. The extruder according to one of claims 7 to 11 or according to claim 13, characterized in that the maximum diameter of the kneading disks (61, 62, 63, . . . ; 61*, 62*, 63*, . . . ) of the dispersing section (6′; 6*) increases along the product conveying direction.

15. The extruder according to one of the preceding claims, characterized in that the diameter of each respective kneading disk (41, 42, 43, . . . ; 41*, 42*, 43*, . . . ; 61, 62, 63, . . . ; 61*, 62*, 63*, . . . ) varies at different axial positions along its width.

16. The extruder according to one of the preceding claims, characterized in that the feed zone (2) or conveying area is at least as long as the sum of lengths of the masticating/plasticizing zone (4) and the dispersing zone (6).

17. The extruder according to one of the preceding claims, characterized in that the feed zone (2) has distributive or non-tightly-combing elements.

18. The extruder according to one of the preceding claims, characterized in that the multiple-shaft extruder is a ring extruder (30), which has both a casing and a core cooling system (31, 32).

19. The extruder according to one of the preceding claims, characterized in that the extruder has a shaping device at its conveyor-downstream end.

20. The extruder according to claim 19, characterized in that a discharge apparatus is provided between the conveyor-downstream extruder end and the shaping device.

21. A procedure for compounding and/or molding an elastomer laced with filler, in particular rubber, with a softener and/or additives, by means of an extruder according to one of claims 1 to 20, wherein the procedure involves the following steps:
Metering in the elastomer as well as the softener and/or the additives;
Masticating/plasticizing the product with at least one kneading element, wherein the elastomer is brought into the state of a pourable, coherent mixture along with the softener and/or the additives; and
Dispersing the product with at least one other kneading element, wherein the filler in the elastomer is comminuted and distributed,
characterized in that
the shafts carrying the kneading elements are operated in such a way as to achieve shearing rates of about 10/s to about 3000/s, in particular between 30/s and 1000/s, between the combs of the kneading elements and the interior casing wall.

22. The procedure according to claim 21, characterized in that the softener and/or the additives are metered in in a conveyor-upstream end area (2a) of the feed zone (2).

23. The procedure according to claim 21, characterized in that he softener and/or the additives are metered in distributed along the product conveying direction over at least a partial area (2a, 2b, 2c) of the feed zone (2).

24. The procedure according to claim 23, characterized in that the softener and/or the additives are metered in in a conveyor-downstream partial area (2c) of the feed zone (2).

25. The procedure according to one of claims 21 to 24, characterized in that degasification takes place in the area of the masticating/plasticizing zone (2) and/or the dispersing zone (4).

26. The procedure according to one of claims 21 to 25, characterized in that water is metered in in the area of the feed zone (2).

27. The procedure according to one of claims 21 to 26 with the use of an extruder according to claim 18, characterized in that both the casing and the core of the multiple-shaft extruder (30) are cooled.

28. The procedure according to one of claims 21 to 27, characterized in that the product is discharged at the conveyor-downstream end of the extruder.

29. The procedure according to claim 28, characterized in that the product is shaped after the product has been discharged.

30. The procedure according to one of claims 21 to 29, characterized in that parts of the additives and/or softeners are already integrated in the elastomer to be compounded or molded.
